(19) United States
(12) Patent Application Publication
(10) Pub. No.: US 2019/0308896 A1
(43) Pub. Date: Oct. 10, 2019

(54) Technological appliance for fishponds and aquacultures to remove viruses, pathogenic bacteria, fungi and toxic algae and make grown fish and shrimp ecologically more relevant for humans consumption

(71) Applicant: Arevik Minasyan, Glendale, CA (US)

(72) Inventor: Arevik Minasyan, Glendale, CA (US)

(21) Appl. No.: 15/947,807

(22) Filed: Apr. 7, 2018

(51) Int. Cl. C02F 3/32; A01K 61/13; A01K 61/95; A01K 63/04; A01K 63/10

(52) U.S. Cl. CPC C02F 3/327; A01K 61/13; C02F 2103/20; A01K 63/04; A01K 63/10; A01K 61/95

(57) ABSTRACT

Innovative technological appliance is designed to guarantee cleaning waters of fishponds and aquacultures, including the deeper parts. The cleaning system will be with containers of ellipsoid shape to increase the surface. The size of the containers will be calculated based on the size of fishpond or aquaculture and on level of water pollution. The appliance carcass will be made from metal and covered with nontoxic waterproof material. The mesh with pore-size of 1 millimeter will be applied to cover the container carcass to keep pre-treated Daphnia inside. The pre-treated Daphnia with activated resistance inside the containers mean to remove all the viruses, pathogenic bacteria, fungi and toxic algae. Main function of containers is to protect fish from consuming intoxicated Daphnia. Fish will become ecologically more relevant for humans consumption. Since Daphnia magna is the biggest among all Daphnia species, if the fishpond is artificial and with no natural Daphnia community, then Daphnia magna will be applied to increase the volume of filtered water. For waterbodies and aquacultures with natural Daphnia community, Daphnia of the same specie will be applied to preserve the natural biodiversity of local zooplankton in case of any escape.

### DESCRIPTION

Although aquaculture and fishponds provide many benefits, but still there are several negative concerns linked to them, and correct foresight into these reverse feedbacks can be avoided. The impact fish farming and aquaculture present to the areas is mainly linked to the requirement to manage and ensure a sustainable operation.

Water pollution is a primary concern aquaculture and fishponds have on the surrounding environment. A successful fish farm, for example, requires fish food to sustain its stock. As with any other agricultural practices, the consumption of food by the stock results in waste products. Because the population of a species in a fish farm is significantly denser than what would occur naturally, the generated waste products are more concentrated as well. For a fish farm, if it were left unchecked, the living conditions for the stock would soon become too toxic for survival. The waste material and products for cages or nets at open-air aquacultures are able to cause more dramatic impact and contaminate the surrounding waters.

This can have a significant trigger on human' s health as we consume fish from fishponds and aquaculture. Poorly managed fish farms can also become a source for diseases, since pathogenic microorganisms are the best to survive in the toxic conditions, where other regular microorganisms die. Pathogenic bacteria are not only detrimental to the health and quality of the fish, but otherwise diseases can actually have an impact on the fish farmers and local inhabitants too.

Therefore, the modern fish farms and aquaculture need an innovative solution, which is not provided by now with any of existing methods or technologies, such as aeration and addition of hydrogen peroxide to fishponds directly. Aeration as a method does not remove any extra nutrients itself and it does not degrade any algal toxins, as well as heavy metals, it just stimulates microbial mineralization of existing nutrients. Although, addition of hydrogen peroxide kills all bacteria, inclusive toxin producing cyanobacteria, but hydrogen peroxide kills also bacteria inhabiting the intestinal system of fish. This negatively affect fish immune responses, makes fish weaker and less resistant to pathogenic bacteria. In overall, it increases further requirement in antibiotics.

This invention relates to an appliance to improve quality of fish grown in fishponds and aquacultures. It is designed to not only clean water of fishponds and aquacultures from viruses, pathogenic bacteria, fungi and toxin producing algae, but to remove all those substances from water and reduce the potential risk of algal toxins and other desiase-casuing microorganisms, including pathogenic bacteria, being accumulated in fish and shrimp meat.

Many pronounced evidences link eutrophication to depress immunity of zoo-population of aquatic ecosystem, including Daphnia. Algal high density reduces the protecting capacity of Daphnia to disease-causing microorganisms (various viruses, bacterial pathogens, fungal infections, etc.), as well as toxins, including cyanotoxins, domoic acid, dinotoxins.

Daphnia is a genus of small planktonic organisms from order Cladocera of phylum Crustacean. Daphnia is a group of organisms living in various aquatic environments ranging from acidic swamps to freshwater and saline lakes, natural and man-made ponds, streams and rivers. Daphnia are typical filter-type feeders, ingesting mainly bacteria, algae, including cyanobacteria, green algae, diatoms, various types of organic detritus, protists, etc.

Due to their filtering feeding type, Daphnia play very significant ecological role in maintaining water quality in aquatic ecosystems, and therefore, based on the high sensitivity to their chemical environment, Daphnia are most commonly extra-added to many aquatic ecosystems to preserve water quality necessary to support healthy riparian, aquatic, and wetland ecosystems to remain in the range required by the biological, physical, and chemical integrity of the system and benefits survival, growth, reproduction, and migration of individuals composing aquatic and riparian communities.

Innovative technological appliance is designed to guarantee cleaning waters of fishponds and aquacultures, including the deeper parts. The size of the innovative appliance will be calculated and desinged based on the size of fishpond and aquaculture the appliance will be placed in. It is a technological innovative decision to be linked to the US patent (application Ser. No. 15/702,859, pending) “Application of Daphnia with reinforced immunity as bio-filters to improve water quality of aquatic ecosystems”. On one hand, Daphnia with reinforced immunity will filter water of fishponds and aquacultures from bacteria (including pathogens) and algae (including toxin-producing strains), as well as viruses and fungi and improve water quality of aquatic ecosystems, on the other, the innovative appliance will prevent intoxicated Daphnia from being consumed by fish, and therefore, the technology will become a pathogenic bacteria and algal toxins remover from food chain, as all these substances and microorganisms will get accumulated in completely isolated Daphnia. Innovative technological appliance will be with containers of ellipsoid shape to increase the surface. The size of the containers will be calculated based on the size of fishpond or aquaculture and level of water pollution. The appliance carcass will be made from metal and covered with nontoxic waterproof material. The mesh with pore-size of 1 millimeter will be applied to cover the container' carcass to keep pre-treated Daphnia inside. The pre-treated Daphnia with activated resistance inside the containers mean to remove all the pathogenic bacteria and toxic algae. Main function of containers is to protect fish from consuming intoxicated Daphnia. Fish will become ecologically more relevant for humans consumption. Since Daphnia magna is the biggest among all Daphnia species, if the fishpond is artificial and with no natural Daphnia community, then Daphnia magna will be applied to increase the volume of filtered water. For waterbodies and aquacultures with natural Daphnia community, Daphnia of the same specie will be applied to preserve the natural biodiversity of local zooplankton if escape happens.

On one or both sides of the appliance the fan/s will be placed to generate water-flow to export microorganisms from the different parts of the fishponds and aquacultures. At the top of the container there is a hermetically sealing hole for injection of special dietary to reinforce Daphnia immunity and keep it active against disease-causing microorganisms and toxic algae. The entire system is designed to guarantee cleaning waters of fishponds and aquacultures, including the deeper parts. The containers, fixed on the appliance with hooks, will be removed from the waterbody two or three times daily to clean the mesh (timing for the cleaning will be scheduled based on the level of water pollution). The number of installed containers per appliance, as well as the quantity of Daphnia per containers, will be calculated depending on the volume of water in fishpond or aquaculture to be filtered by Daphnia, to ensure proper treatment. As this innovative device eliminates pathogens and toxic algae too, the addition of any fungicide/bactericide/algaecide chemicals is no longer required.

To increase the economical efficiency, the containers with Daphnia will be exchanged with the new containers after 24-72 hrs exploitation. The old containers with Daphnia from fishpond or aquaculture will be placed in autoclaved or boiled and afterwards chilled fishpond water for 12 hrs to remove all accumulated in Daphnia body algal toxins and pathogenic bacteria, viruses and fungi, etc. Next 12 hrs Daphnia will be placed in the tanks with special dietary to strengthen the animal's resistance to algal toxins and pathogenic bacteria. After the containers will be returned to the fishponds or aquaculture. The cycling exchange will be done between old and new containers with pre-treated Daphnia.

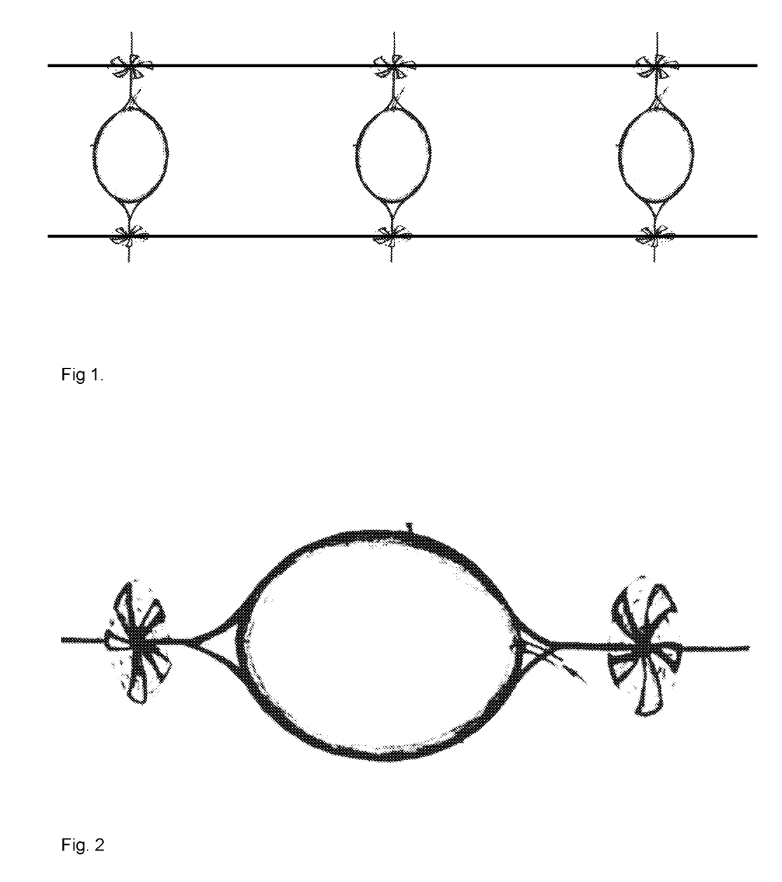

On the drawings FIG. 1 illustrates the appliance with several containers together with fans that stimulate the water flow from the different parts of the fishpond or aquaculture.

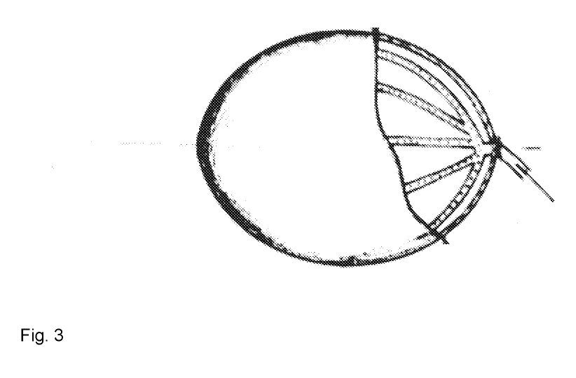

FIG. 2 represents a single container with the schematic illustration of the hermetically sealing hole at the top of container. It means for injection of a specific dietary into the container to stimulate Daphnia resistance to pathogens and algal toxins.

FIG. 3 demonstrates the inner structure of the container made of metallic carcass and covered with mesh of 1-millimeter pore-size.

1. Pre-treated Daphnia, with stimulated resistance against disease causing microorganims and toxic algae, inside the containers of the innovative appliance clean water of fishponds and aquacultures from excessive abundance of bacteria, including pathogens and algae, including toxin-producing species and strains, fungi, viruses and other type of microorganisms.

2. Replaceable containers clean water from all type of disease-causing viruses, fungi, bacteria and algae as Daphnia will pass the full 12/12 hrs cycles of body cleaning in autoclaved pond water and stimulation of the immunity response with special dietary.

3. The appliance helps to grow eco-fish as it prevents the fish from consuming Daphnia intoxicated with pathogenic bacteria and algal toxins and removes all toxic substances from fishponds and aquacutlures.
